(19) United States
(12) Patent Application Publication
(10) Pub. No.: US 2017/0195520 A1
(43) Pub. Date: Jul. 6, 2017

(54) IMAGE PROCESSING METHOD, APPARATUS, AND IMAGE FORMING DEVICE

(71) Applicant: Zhuhai Seine Technology CO., Ltd., Zhuhai (CN)

(72) Inventors: Jibing PENG, Zhuhai (CN); Yangxiao MA, Zhuhai (CN)

(21) Appl. No.: 15/394,331

(22) Filed: Dec. 29, 2016

(30) Foreign Application Priority Data
Dec. 30, 2015 (CN) 2015-11029306.0

(51) Int. Cl. H04N 1/405

(52) U.S. Cl. CPC H04N 1/4052; H04N 2201/0081

(57) ABSTRACT

In various embodiments, an image processing method using self-adaptive error diffusion algorithm, a related apparatus and device are provided. In some embodiments, the method comprises: determining a neighboring region in an original image for error diffusion process, the neighboring region including a center point and its adjacent points; based on pixel values of the center point and the adjacent points, calculating an error diffusion process weight value for each adjacent point corresponding to an error diffusion process from the center point towards each adjacent point; after binarizing the pixel value of the center point, calculating an error value according to the binarized pixel value of the center point; adding a product of the error diffusion process weight value for each adjacent point and the error value to the pixel value of each adjacent point respectively to obtain an error-diffusion-processed pixel value for each adjacent point in the neighboring region.

### CROSS-REFERENCES TO RELATED APPLICATIONS

This application claims the priority of Chinese Patent Application No. 201511029306.0, filed on Dec. 30, 2015, the entire content of which is incorporated herein by reference.

### FIELD OF THE DISCLOSURE

The present disclosure generally relates to the field of image processing and, more particularly, relates to an image processing method using self-adaptive error diffusion algorithm and for adjusting image quality, a related image processing apparatus, and a related image forming device.

### BACKGROUND

Halftone, also known as gray-scale, is a technical index for indicating an image brightness level, and a black/white contrast change. For example, if an image processing apparatus has a higher level of the halftone, the images recorded and outputted by the image processing apparatus can have richer image gradation, and more realistic color details. Error diffusion method is an algorithm commonly used in image halftone processing. An image processed by the error diffusion algorithm can have various advantages, such as good visual effect, easy realization, etc. Therefore, the error diffusion algorithm is considered as one of the ideal halftone algorithms.

The basic idea of the error diffusion algorithm is to compare a current pixel value of a grayscale image with a threshold value to obtain a binary output, and then diffuse a pixel difference between the input and output to an unprocessed region in a certain way. The error diffusion process for each pixel includes the following three steps.

At a first step, a pixel value of the pixel of the original grayscale image can be added to an error previously diffused to the pixel to obtain a current input.

At a second step, the current input can be compared with the threshold to obtain a binary output (0 or 255).

At a third step, the error of the current input and the binary output can be diffused to unprocessed areas in accordance with a certain rule.

Currently, the “certain rule” mentioned above in the third step can be referred to a number of weight distribution methods for the error diffusion filter. However, the values of the weights are all fixed values which are set in advance.

Further, the current error diffusion processing may not result desired image effect for some processed images. Especially, some obvious artificial texture marks may be generated after the image processing.

The disclosed method and apparatus are directed to solve one or more problems set forth above and other problems.

### BRIEF SUMMARY OF THE DISCLOSURE

In accordance with some embodiments of the present disclosure, an image processing method using self-adaptive error diffusion algorithm and for adjusting image quality, a related image processing apparatus, and a related image forming device are provided.

An aspect of the present disclosure provides a method for image processing, comprising: determining a neighboring region in an original image for error diffusion process, the neighboring region including a center point and at least one adjacent point of the center point; based on pixel values of the center point and the at least one adjacent point, calculating an error diffusion process weight value for each adjacent point in the neighboring region corresponding to an error diffusion process from the center point towards each adjacent point; after binarizing the pixel value of the center point, calculating an error value according to the binarized pixel value of the center point; and adding a product of the error diffusion process weight value for each adjacent point and the error value to the pixel value of each adjacent point in the neighboring region respectively to obtain an error-diffusion-processed pixel value for each adjacent point in the neighboring region.

In some embodiments, the error diffusion process weight value for each adjacent point is calculated based on a predetermined function of the pixel values of the center point and the adjacent points in the neighboring region.

In some embodiments, the method further comprises: selecting another pixel in the original image that is directly adjacent to the center point as a next center point; determining a next neighboring region of the next center point, the next neighboring region includes the next center point and at least one adjacent point of the next center point; based on pixel values of the next center point and the at least one adjacent point in the next neighboring region, calculating an error diffusion process weight value for each adjacent point in the next neighboring region corresponding to an error diffusion process from the next center point towards each adjacent point in next neighboring region; binarizing the pixel value of the next center point, and calculating an error value according to the binarized pixel value of the next center point; and adding a product of the error diffusion process weight value for each adjacent point in the next neighboring region and the error value to the pixel value of each adjacent point in the next neighboring region respectively to obtain an error diffusion processed pixel value for each adjacent point in the next neighboring region.

In some embodiments, the predetermined function is

$$w ( m , n ) = \frac{\vert src ( i , j ) - src ( i + m , j + n ) \vert}{Y + {\sum }_{m = - M 1}^{M 2} {\sum }_{n = - N 1}^{N 2} \vert src ( i , j ) - src ( i + m , j + n ) \vert} ;$$

src(i, j) is the pixel value of the center point (i, j) in the neighboring region; src(i+m, j+n) is the pixel value of the adjacent point (i+m, j+n) that is located at the m column right side of the center point and n row down side of the center point; w(m, n) is the error diffusion process weight value of the adjacent point (i+m, j+n) in the neighboring region; M2 is a maximum value of m when the adjacent point in located on the right side of the center point; N2 is a maximum value of n when the adjacent point is located below the center point; M1 is a maximum absolute value of m when the adjacent point is located on the left side of the center point; N1 is a maximum absolute value of n when the adjacent point is located above the center point; and Y is a predetermined integer value arbitrarily selected from 1-255.

In some embodiments, the predetermined function is

$$w ( m , n ) = \frac{\vert {src ( i , j )}^{2} - {src ( i + m , j + n )}^{2} \vert}{Y + {\sum }_{m = - M 1}^{M 2} {\sum }_{n = - N 1}^{N 2} \vert {src ( i , j )}^{2} - {src ( i + m , j + n )}^{2} \vert} ;$$

src(i, j) is the pixel value of the center point (i, j) in the neighboring region; src(i+m, j+n) is the pixel value of the adjacent point (i+m, j+n) that is located at the m column right side of the center point and n row down side of the center point; w(m, n) is the error diffusion process weight value of the adjacent point (i+m, j+n) in the neighboring region; M2 is a maximum value of m when the adjacent point in located on the right side of the center point; N2 is a maximum value of n when the adjacent point is located below the center point; M1 is a maximum absolute value of m when the adjacent point is located on the left side of the center point; N1 is a maximum absolute value of n when the adjacent point is located above the center point; and Y is a predetermined integer value arbitrarily selected from 1-255.

In some embodiments, binarizing the pixel value of the center point includes: calculating an average pixel value of the neighboring region; if the average pixel value of the neighboring region is less than or equal to a preset threshold value, assigning a first fixed value to the binarized pixel value of the center point; and if the average pixel value of the neighboring region is larger than the preset value, assigning a second fixed value to the binarized pixel value of the center point, the second fixed value is different than the first fixed value.

In some embodiments, the preset threshold value is calculated based on the pixel values of the center point and adjacent points in the neighboring region.

In some embodiments, the average pixel value of the neighboring region is calculated by

$$Average = \frac{{\sum }_{m = - M 1}^{M 2} {\sum }_{n = - N 1}^{N 2} src ( i + m , j + n )}{( M 1 + M 2 + 1 ) \times ( N 1 + N 2 + 1 ) - Z} ;$$

the “Average” is the average of the pixel values of all the pixels including the center point and all adjacent points in the neighboring region; src(i+m, j+n) is the pixel value of the adjacent point (i+m, j+n) that is located at the m column right side of the center point and n row down side of the center point; Z is a total number of pixel points in the neighboring region that do not participate in the error diffusion; N1+N2+1 is a total number of rows in the neighboring region; and M1+M2+1 is a total number of columns in the neighboring region.

In some embodiments, calculating the error value according to the binarized pixel value of the center point includes: subtracting the binarized pixel value of the center point from the pixel value of the center point.

In some embodiments, the error-diffusion-processed pixel value of each adjacent point in the neighboring region is calculated by

src(i+m, j+n)′=w(m,n)×error+src(i+m, j+n); src(i+m, j+n) is the pixel value of the adjacent point (i+m, j+n) that is located at them column right side of the center point and n row down side of the center point; w(m, n) is the error diffusion process weight value of the adjacent point (i+m, j+n); error is the error value; and src(i+m, j+n)′ is the error diffusion processed pixel value of the adjacent point (i+m, j+n) in the neighboring region of the central point (i, j).

Another aspect of the present disclosure provides an apparatus for image processing, comprising: a neighboring region error diffusion matrix generator configured for determining a neighboring region in an original image for error diffusion process, the neighboring region includes a center point and at least one adjacent point of the center point; an error diffusion weight coefficient calculator configured for, based on pixel values of the center point and the at least one adjacent point, calculating an error diffusion process weight value for each adjacent point in the neighboring region corresponding to an error diffusion process from the center point towards each adjacent point; an error diffusion binarization calculator configured for binarizing the pixel value of the center point, and calculating an error value according to the binarized pixel value of the center point; and an error diffusion processor configured for adding a product of error diffusion process weight value for each adjacent point and the error value to the pixel value of each adjacent point in the neighboring region respectively to obtain an error diffusion processed pixel value for each adjacent point in the neighboring region.

In some embodiments, the error diffusion weight coefficient calculator includes: a gradient computing unit array connected to the center point and each adjacent point in the neighboring region; a first summation computing unit array connected to the gradient computing unit array; and a division computing unit array connected to both of the gradient computing unit array and the first summing computing unit array.

In some embodiments, the error diffusion weight coefficient calculator includes: a variance computing unit array including a square value computing unit array and a subtraction computing unit array connected to the center point and each adjacent point in the neighboring region; a first summation computing unit array connected to the gradient computing unit array; and a division computing unit array connected to both of the gradient computing unit array and the first summing computing unit array; the variance computing unit array includes a square value computing unit array and a subtraction computing unit array.

In some embodiments, the neighboring region error diffusion matrix generator is further configured for selecting another pixel in the original image that is directly adjacent to the center point as a next center point, and determining a next neighboring region of the next center point, the next neighboring region includes the next center point and at least one adjacent point of the next center point; the error diffusion weight coefficient calculator is further configured for, based on pixel values of the next center point and the at least one adjacent point in the next neighboring region, calculating an error diffusion process weight value for each adjacent point in the next neighboring region corresponding to an error diffusion process from the next center point towards each adjacent point in next neighboring region; the error diffusion binarization calculator is further configured for binarizing the pixel value of the next center point, and calculating an error value according to the binarized pixel value of the next center point; and the error diffusion processor is further configured for adding a product of the error diffusion process weight value for each adjacent point in the next neighboring region and the error value to the pixel value of each adjacent point in the next neighboring region respectively to obtain an error diffusion processed pixel value for each adjacent point in the next neighboring region.

In some embodiments, the error diffusion binarization calculator includes: a second summation computing unit array connected to the center point and each point in the neighboring region; an average value computing unit connected to the second summation computing unit array; and a threshold comparison unit connected to the average value computing unit.

In some embodiments, the error diffusion processor includes: a multiplication computing unit array connected to both of the error diffusion weight coefficient calculator and the error diffusion binarization calculator; and a third summation computing unit array connected to the multiplication computing unit array, the center point and each adjacent point in the neighboring region.

In some embodiments, the error diffusion binarization calculator is further configured for subtracting the binarized pixel value of the center point from the pixel value of the center point to obtain the error value.

Another aspect of the present disclosure provides a device for forming an image, comprising: a reading apparatus for providing raw image processing data of the original image; an image parameter acquiring apparatus configured for acquiring pixel values of the original image; a disclosed image processing apparatus connected to the image parameter acquiring apparatus; and an output apparatus for outputting processed data generated by the image processing apparatus.

Other aspects of the present disclosure can be understood by those skilled in the art in light of the description, the claims, and the drawings of the present disclosure.

### BRIEF DESCRIPTION OF THE DRAWINGS

Various objectives, features, and advantages of the present disclosure can be more fully appreciated with reference to the detailed description of the present disclosure when considered in connection with the following drawings, in which like reference numerals identify like elements. It should be noted that the following drawings are merely examples for illustrative purposes according to various disclosed embodiments and are not intended to limit the scope of the present disclosure.

FIG. 1 illustrates a flowchart of an image processing method for self-adaptively adjusting error diffusion weight coefficients in accordance with some embodiments of the present disclosure;

FIG. 2 illustrates a block diagram of an exemplary configuration of an image processing apparatus in accordance with some embodiments of the present disclosure;

FIG. 3 illustrates a hardware circuit diagram of an exemplary image processing apparatus in accordance with some embodiments of the present disclosure;

FIG. 4 illustrates an unprocessed original image exemplified in accordance with some embodiments of the present disclosure;

FIG. 5 illustrates a schematic view of a halftone image processed by a current error diffusion filter;

FIG. 6 illustrates a schematic view of a halftone image processed by an image processing apparatus in accordance with some embodiments of the present disclosure;

FIG. 7 illustrates a partially enlarged schematic view of a halftone image processed by a current error diffusion filter;

FIG. 8 illustrates a partially enlarged schematic view of a halftone image processed by an image processing apparatus in accordance with some embodiments of the present disclosure;

FIG. 9 illustrate image comparison effect diagrams in accordance with some embodiments of the present disclosure; and

FIG. 10 illustrates another hardware circuit diagram of an exemplary image processing apparatus in accordance with some other embodiments of the present disclosure.

### DETAILED DESCRIPTION

Reference input now be made in detail to exemplary embodiments of the invention, which are illustrated in the accompanying drawings in order to fully understand and being able to implementing the present disclosure and to realizing the technical effect. It should be understood that the following description has been made only by way of example, but not to limit the present disclosure. Various embodiments of the present disclosure and various features in the embodiments that are not conflicted with each other can be combined and rearranged in various ways. Without departing from the spirit and scope of the disclosed subject matter, modifications, equivalents, or improvements to the disclosed subject matter are understandable to those skilled in the art and are intended to be encompassed within the scope of the present disclosure.

In addition, the steps illustrated in the flowcharts of the figures may be performed in a control device such as a set of controllers capable of executing instructions. Although the flowcharts show some logical orders, in some cases the steps shown or described can be performed in sequences different from the logical orders shown in the flowcharts.

Hereinafter, embodiments consistent with the disclosure will be described with reference to the drawings.

In accordance with various embodiments, the present disclosure provides an image processing method using self-adaptive error diffusion algorithm and for adjusting image quality, a related image processing apparatus, and a related image forming device.

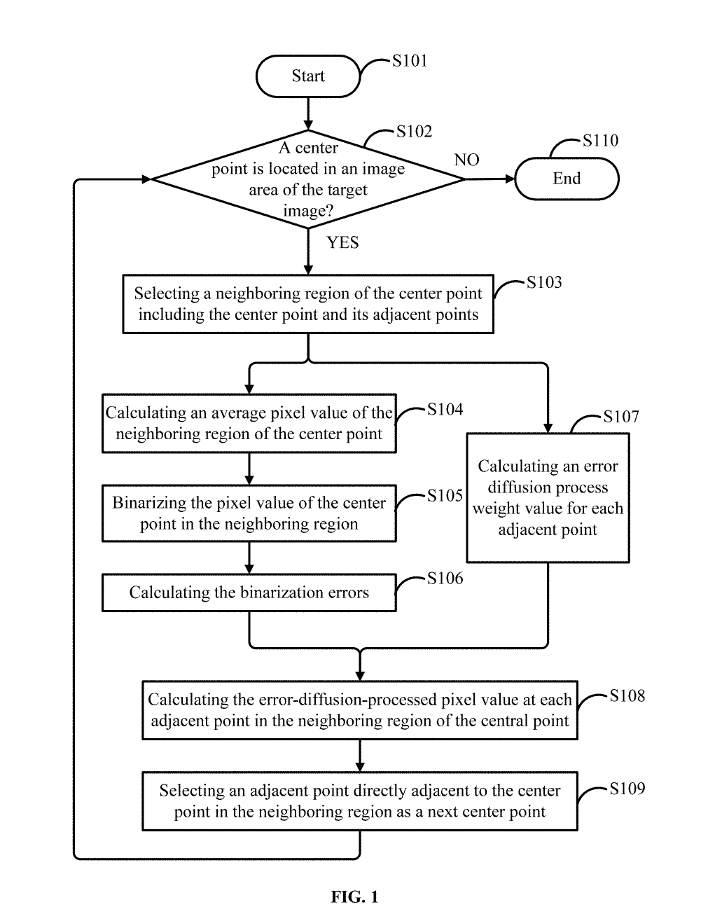

Referring to FIG. 1, a flowchart of an image processing method for adaptively adjusting error diffusion weight coefficients is shown in accordance with some embodiments of the present disclosure. As illustrated in FIG. 1, the method can include the following steps.

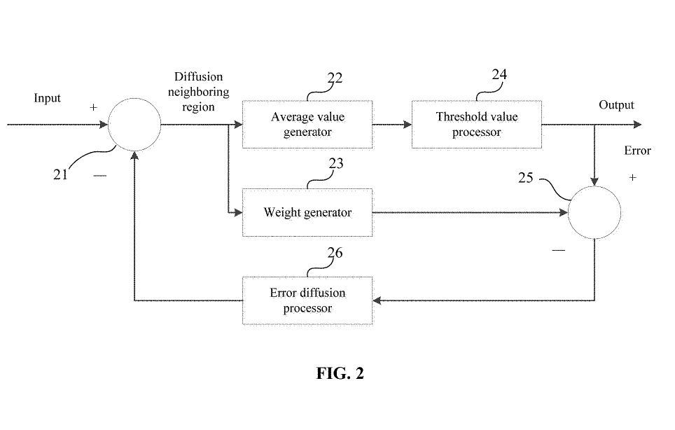

Step S101: At the beginning, an image processing apparatus (explained in details below in connection with FIGS. 2, 3 and 10) can issue a command to start an error diffusion processing operation for an original image.

Step S102: it can be determined whether a center point is located in an image area of the original image.

The original image can be a converted digital signal image which has been subjected to analog-to-digital conversion. That is, the image is a digitally represented image. The center point refers to, when performing the error diffusion process, a pixel point from which the error diffusion process can be diffused to neighboring adjacent points to correct the pixel values of the neighboring adjacent points.

When it is determined that the center point is located in the image area of the original image, step S103 can be executed. Otherwise, step S110 can be executed.

Step S103: a neighboring region of the center point, including the center point and its neighboring adjacent points or simply adjacent points, can be selected.

The center point (i, j) in the neighboring region has a pixel value of src(i, j). An adjacent point (i+m, j+n) that is located at the m column right side of the center point and n row down side of the center point has a pixel value of src(i+m, j+n). w(i+m, j+n) is a weight value of the error diffusion calculation from the center point to the adjacent point (i+m, j+n). As used herein, i and m, may be integers representing column number, and j and n may be integers representing row number.

When m is a negative number, it indicates that the adjacent point (i+m, j+n) in the neighboring region is located on the left side of the center point. When n is a negative number, it indicates that the adjacent point (i+m, j+n) in the neighboring region is located above the center point.

Further, M2 is a maximum value of m when the adjacent point in located on the right side of the center point. N2 is a maximum value of n when the adjacent point is located below the center point. M1 is a maximum absolute value of m when the adjacent point is located on the left side of the center point. N1 is a maximum absolute value of n when the adjacent point is located above the center point. Y is a predetermined integer value arbitrarily selected from 1-255.

Step S104: an average pixel value of the neighboring region of the center point can be calculated.

In some embodiments, the average pixel value of the neighboring region can be calculated by using the equation of:

$$Average = \frac{{\sum }_{m = - M 1}^{M 2} {\sum }_{n = - N 1}^{N 2} src ( i + m , j + n )}{( M 1 + M 2 + 1 ) \times ( N 1 + N 2 + 1 ) - Z} , \qquad ( 1 ) .$$

The “Average” in equation (1) represents the average of the pixel values of all the pixels including the center point and all adjacent points in the neighboring region. Z represents a total number of pixel points that do not participate in the error diffusion in the neighboring region (or in a pixel matrix of the neighboring region). N1+N2+1 represents a total number of rows in the neighboring region. M1+M2+1 is a total number of columns in the neighboring region.

That is, the numerator in equation (1) is a summation of the pixel values of all pixel points including the center point and all adjacent points in the neighboring region, and the denominator in equation (1) is a total number of pixel points including the center point and all adjacent points in the neighboring region that participate in the error diffusion.

Step S105: the pixel value of the center point in the neighboring region can be binarized.

In some embodiments, the binarization of the pixel value of the center point in the neighboring region can be calculated by using the following equation:

bw(i,j)=X1, when Average≦X;

bw(i,j)=X2, when Average>X; (2).

That is, when the “Average” in equation (1) is less than or equal to a preset value X, the binarized pixel value of the center point can be assigned to value of X1. Otherwise, the binarized pixel value of the center point can be assigned to value of X2.

In some embodiments, X can be 256/2=128, X1=0, and X2=255. However, the preset values (or threshold values) of X, X1 and X2 are not limited to fixed threshold values. In some other embodiments, the values of X, X1 and X2 can be calculated by combining the pixel values in the neighboring region, such as, one-half of src(i, j), or an average of pixel values of adjacent points in the neighboring region, etc.

By using the above method for comparing the average value and threshold value, rather than simply using the center pixel value directly, the result of the binarization processing can be combined with the properties of the pixels within the entire neighboring region. As such, a too large calculation deviation that affects the image processing results may be avoid even if the pixel value of the center point has large differences with the pixel values of the adjacent points.

Step S106: the binarization errors can be calculated. In some embodiments, in conjunction with the calculation result of equation (2) in step S105, the binarization error values for each adjacent point in the neighboring region of the center point can be calculated by using the equation of:

error=(src(i,j)−bw(i,j)), (3).

Step S107: error diffusion process weight values can be calculated.

Based on the pixel values of the center point and the adjacent points in the neighboring region, at least one weight value of the error diffusion processing from the center point to one adjacent point can be calculated by a predetermined function.

In some embodiments, the predetermined function is a gradient equation:

$$w ( m , n ) = \frac{\vert src ( i , j ) - src ( i + m , j + n ) \vert}{Y + {\sum }_{m = - M}^{M 2} {\sum }_{n = - N 1}^{N 2} \vert src ( i , j ) - src ( i + m , j + n ) \vert} , \qquad ( 4 ) .$$

In equation (4), w(m, n) denotes the error diffusion process weight value of the adjacent point (i+m, j+n) in the neighboring region, which is the pixel point located at the m columns on the right side of the center point, and at the n rows below the center point.

It should be noted that, the neighboring region used herein may not necessarily to have a regular rectangle shape, so that the values of m and n may not be necessarily continuous values, and can be defined as scattered values. For example, for the row i+m, when M1=0, the error diffusion can be only diffused to the lower direction; when N1=0, the error diffusion can be only diffused to the right direction. As another example, the direction of the error diffusion can be restricted in only the left or the right direction for certain rows, such as m=0 and N1 is forced to be equal to 0. Accordingly, the values of M1, M2, N1 and N2 in equation (4) are not limited to the conventional mathematical formulas, and more additional conditions can be added according to the actual demand.

Since the weight values of the error diffusion process are calculated by a predetermined function combining the pixel values of the center point and the adjacent points in the neighboring region, the error diffusion processing result can be dynamically adjusted according to the pixel characteristics of the entire neighboring region. That is, rather than processing the error diffusion to all the neighboring regions in accordance with one type of diffusion weight value, different local characteristics of the neighboring regions can be involved in the disclosed error diffusion process. As such, the embodiments of the disclosed image processing method can obtain desired image processing effect, and the specific simulation effects are described in detail below.

Step S108: calculating the error-diffusion-processed pixel value of each pixel of the neighboring region after the error diffusion process is performed.

In some embodiments, the product of the weight value of each adjacent point and the error value can be added with the pixel value of the corresponding adjacent point in the neighboring region of the central point. The resulted value is the error-diffusion-processed pixel value of the corresponding adjacent point in the neighboring region of the central point. A specific calculation equation is:

src(i+m,j+n)′=w(m,n)×error+src(i+m,j+n), (5),

where src(i+m, j+n)′ is the error diffusion processed pixel value of the adjacent point (i+m, j+n) in the neighboring region of the central point (i, j).

Step S109: an adjacent point directly adjacent to the center point in the neighboring region can be selected as a next center point, and then the process can return to step S102.

In some embodiments, the next central point can be selected by traversing each line sequentially to the right direction in accordance with the line numbers of the digital image. For example, M1=0 when the center point is the leftmost pixel of a row, M2=0 when the center point is the rightmost of a row, N1=0 when the center point is at the first row, and N2=0 when the center point is at the last row.

Step S110: the error diffusion processing for the original image is completed.

It should be noted that, there is no prioritization between steps S104-S106 and S107. Step S107 may be performed earlier than or later than any one of steps S104-S106.

Referring to FIG. 2, a block diagram of an exemplary configuration of an image processing apparatus is shown in accordance with some embodiments of the present disclosure. As illustrated in FIG. 2, the disclosed image processing apparatus can include a neighborhood error diffusion matrix generator, an error diffusion weight coefficient calculator 23, an error diffusion binarization calculator (not labeled), and an error diffusion processor 26.

The neighboring region error diffusion matrix generator can be used for determining a neighboring region of a selected center point for an error diffusion process from an original image, and the neighboring region includes center point and at least one adjacent point of the center point. That is, the neighboring region error diffusion matrix generator can perform the step S103 in FIG. 1.

The error diffusion weight coefficient calculator, or simply called a weight generator 23, can be used for calculating a weight value for the error diffusion process from the center point to an adjacent point based on the pixel values of the center point and the adjacent point in the neighboring region by a predetermined function. That is, the weight generator 23 can perform the step S107 in FIG. 1.

The error diffusion binarization calculator can include an average value generator 22 and a threshold value processor 24. The error diffusion binarization calculator can be used for binarizing the pixel value of the center point, and calculating an error value based on the result of the binarization processing. That is, the error diffusion binarization calculator can perform the steps S104 to S106 in FIG. 1.

The error diffusion processor 26 can include a node 25 for multiplying the weight value of each adjacent point and the error value, and a node 21 for adding the product of the weight value of each adjacent point and the error value with the pixel value of the corresponding adjacent point in the neighboring region of the central point. The resulted value of the summation is the error diffusion processed pixel value of the corresponding adjacent point in the neighboring region of the central point.

In some embodiments, the error diffusion weight coefficient calculator can include a gradient computing unit array connected to the center point and the adjacent points in the neighboring region, a first summation computing unit array connected to the gradient computing unit array, and a division computing unit array connected to both of the gradient computing unit array and the first summing computing unit array.

In some embodiments, the error diffusion binarization calculator can include a second summation computing unit array connected to the center point and the adjacent points in the neighboring region, an average value computing unit connected to the second summation computing unit array, and a threshold comparison unit connected to the average value computing unit.

In some embodiments, the error diffusion processor can include a multiplication computing unit array connected to both of the error diffusion weight coefficient calculator and the error diffusion binarization calculator, and a third summation computing unit array connected to the multiplication computing unit array, the center point and the adjacent point in the neighboring region.

Another the present disclosure also provides an image forming device. The image forming device can include an image parameter acquiring apparatus, an image processing apparatus, an image forming apparatus, a reading apparatus, and an output apparatus, etc.

The image parameter acquiring apparatus can be used for acquiring pixel values of an original image.

The image processing apparatus can be connected to the image parameter acquiring apparatus, and the image processing apparatus can be any one of the above-described image processing apparatus.

The image forming apparatus can be connected to the image processing apparatus, and may include any suitable type of image forming apparatus, such as an ink jet type, an electrostatic image type, or a dot matrix striking type, etc.

The image processing device may further include a reading apparatus for providing raw image processing data, and an output apparatus for outputting the processed data. The reading apparatus can be arranged to include a reading glass table, a Contact Image Sensor (CIS), a reading motor, etc. The output apparatus can be a network card, a USB interface, etc.

In order to further describe the present disclosure, the specific process of applying the error diffusion processing is exemplified in the followings. It is assumed that the neighboring region of a center point includes two rows and three columns, and the error diffusion process is only performed to the adjacent points that located on the right side, left lower side, lower side, and right lower side of the center point.

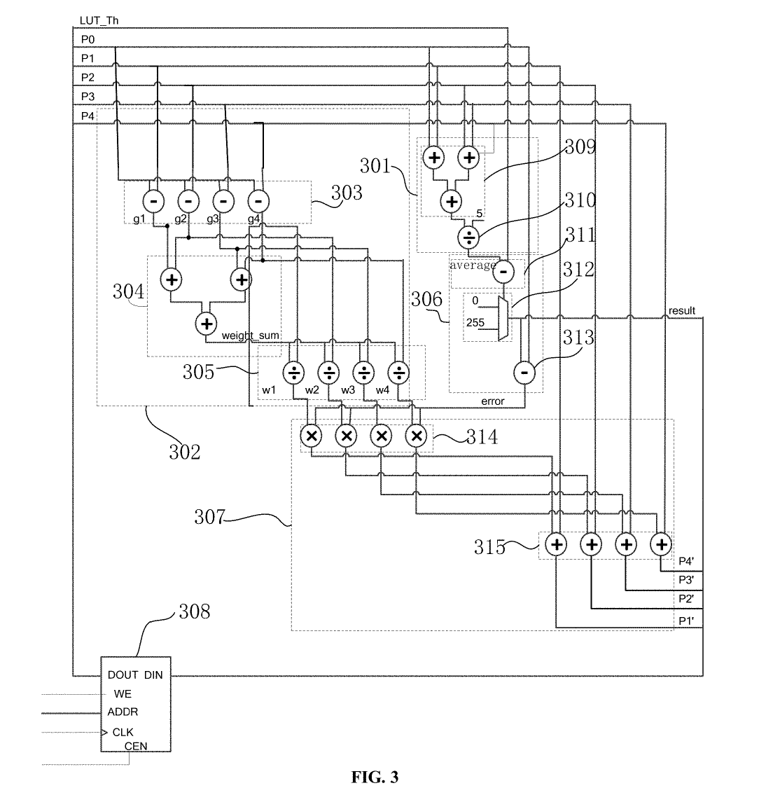

Referring to FIG. 3, a hardware circuit diagram of an exemplary image processing apparatus is shown in accordance with some embodiments of the present disclosure.

As shown in FIG. 3, the error diffusion weight coefficient calculator 302 of the image processing apparatus can include the gradient computing unit array (i.e., the absolute value computing unit array 303) connected to the center point PO and the adjacent points P1, P2, P3 and P4 in the neighboring region, the first summation computing unit array 304 connected to the absolute value computing unit array 303, and the division computing unit array 305 connected to both of the absolute value computing unit array 303 and the first summing computing unit array 304.

The error diffusion binarization calculator can include the second summation computing unit array 309 connected to the center point and the adjacent points in the neighboring region, the average value computing unit 310 connected to the second summation computing unit array 309. The average value computing unit 310 and the second summation computing unit array 309 can constitute an average value generator 301.

The error diffusion binarization calculator can also include the threshold comparison unit 306 connected to the average value generator 301. The threshold value comparison unit 306 can include a first difference calculator 311 connected to the average value generator 301 and the threshold value (i.e., X=LUT−Th), a difference comparator 312 connected to the difference calculator 311, and a second difference calculator 313 connected to the difference comparator 312 and the center point.

The error diffusion processor 307 can include a multiplication computing unit array 314 connected to both of the error diffusion weight coefficient calculator 302 and the error diffusion binarization calculator, and a third summation computing unit array 315 connected to the multiplication computing unit array 314, the center point and the adjacent point in the neighboring region.

By using the image processing apparatus described above, after the error diffusion processing is performed, the pixel values of the respective adjacent points/pixels P1′, P2′, P3′ and P4′ in neighboring region can be calculated. The module 308 can supply processed clock signals to the image processing apparatus, and can also include input and output interfaces of the image processing apparatus.

In the following, a specific example of a neighboring region and pixel values is described to exemplarily explain the error diffusion process. As shown in Table 1 and Table 2 below are two groups of pixels value that have not been processed by an error diffusion.

TABLE 1

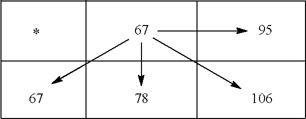

TABLE 2

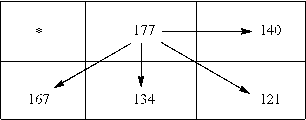

In Table 1, a neighboring region of a center point having a pixel value of 67 is provided. The center point has four adjacent points. The neighboring region is arranged in two rows, three columns. For the first row, the error diffusion is only from the center point towards the right side. For the second row, the error diffusion is from the center point towards all of the three adjacent points of the second row. That is, the entire error diffusion neighboring region (matrix) has an adjacent point (* in Table 1) that does not participate in error diffusion process. Thus, in equation (1), Z=1, M1=1, N2=1. And when m=M1=0, then N1=0, N2=1. When m=M2=1, then N1=−1, N2=1. Therefore, the denominator (M1+M2+1)×(N1+N2+1)−Z of equation (1) should be understood as a total number of adjacent point within the neighboring region that participate in the error diffusion process.

For the neighboring region in Table 1, according to the equation (1), the following result can be calculated:

$$Average = \frac{( 67 + 95 + 67 + 78 + 106 )}{( 2 \times 3 ) - 1} = 82.6 .$$

Since 82.6<X(128), bw (i, j)=X1=0 in equation (2).

Substituting the result obtained from the equation (2) into the equation (3), the binarization error can be calculated: error=82.6.

In some embodiments, Y=1, and the error diffusion process weight value of each adjacent point in the neighboring region of Table 1 can be obtained according to equation (4):

$$w ( 1 , 0 ) = \frac{\vert 67 - 95 \vert}{1 + \vert 67 - 95 \vert + \vert 67 - 67 \vert + \vert 67 - 78 \vert + \vert 67 - 106 \vert} = \frac{28}{79}$$

$$w ( - 1 , - 1 ) = \frac{\vert 67 - 67 \vert}{1 + \vert 67 - 95 \vert + \vert 67 - 67 \vert + \vert 67 - 78 \vert + \vert 67 - 106 \vert} = 0$$

$$w ( 0 , 1 ) = \frac{\vert 67 - 78 \vert}{1 + \vert 67 - 95 \vert + \vert 67 - 67 \vert + \vert 67 - 78 \vert + \vert 67 - 106 \vert} = \frac{11}{79}$$

$$w ( 1 , 1 ) = \frac{\vert 67 - 106 \vert}{1 + \vert 67 - 95 \vert + \vert 67 - 67 \vert + \vert 67 - 78 \vert + \vert 67 - 106 \vert} = \frac{39}{79} .$$

Then the calculation results of the error diffusion process weight values and the binarization error can be into substituted into equation (5) to get:

src(1,0)′= 28/79×82.6+95=124.275

src(−1,−1)′=0×82.6+67=67

src(0,1)′= 11/79×82.6+78=89.5

src(1,1)′= 39/79×82.6+106=146.778

According to the rounding approach, after the error diffusion processing, the error-diffusion-processed pixel value of the adjacent point on the right side of the center point is 124, the error-diffusion-processed pixel value of the adjacent point on the left lower side of the center point is 67, the error-diffusion-processed pixel value of the adjacent point on the lower side of the center point is 90, and the error-diffusion-processed pixel value of the adjacent point on the right lower side of the center point is 147.

Similarly, using same calculation method, the error diffusion process weight value of each adjacent point in the neighboring region of Table 2 can be obtained as:

$$w ( 1 , 0 ) = \frac{\vert 177 - 140 \vert}{1 + \vert 177 - 140 \vert + \vert 177 - 167 \vert + \vert 177 - 134 \vert + \vert 171 - 121 \vert} = \frac{37}{110}$$

$$w ( - 1 , - 1 ) = \frac{\vert 177 - 167 \vert}{1 + \vert 177 - 140 \vert + \vert 177 - 167 \vert + \vert 177 - 134 \vert + \vert 171 - 121 \vert} = \frac{10}{110}$$

$$w ( 0 , 1 ) = \frac{\vert 177 - 134 \vert}{1 + \vert 177 - 140 \vert + \vert 177 - 167 \vert + \vert 177 - 134 \vert + \vert 171 - 121 \vert} = \frac{43}{110}$$

$$w ( 1 , 1 ) = \frac{\vert 177 - 121 \vert}{1 + \vert 177 - 140 \vert + \vert 177 - 167 \vert + \vert 177 - 134 \vert + \vert 177 - 121 \vert} = \frac{19}{110} .$$

The average of the pixel values of the center point and the adjacent points in the neighboring region of Table 2 is

$$Average = \frac{( 177 + 140 + 167 + 134 + 121 )}{( 2 \times 3 ) - 1} = 177.$$

The binarization error is: error=177−255=−78. And

src(1,0)′=− 37/110×78+140≈114

src(−1,−1)′=− 10/110×78+167≈160

src(0,1)′=− 43/110×78+134≈104

src(1,1)′=− 19/110×78+121≈108

Accordingly, for the neighboring region of Table 2, after the error diffusion processing, the pixel value of the adjacent point on the right side of the center point is 114, the error-diffusion-processed pixel value of the adjacent point on the left lower side of the center point is 160, the error-diffusion-processed pixel value of the adjacent point on the lower side of the center point is 104, and the error-diffusion-processed pixel value of the adjacent point on the right lower side of the center point is 108.

It should be noted that, the image processing method provided in the present disclosure is not limited to the hardware implementation, it can also be realized by a software implementation, or an implementation of a combination of software and hardware. For example, an application program for image processing can be combined with a controller, and a self-adaptive image error diffusion process weight value adjustment can be implemented by software, such as using a preset function to calculate the weight values.

Referring to FIGS. 4-9, exemplary advantages of the disclosed image processing method can be shown. FIG. 4 illustrates an unprocessed original image.

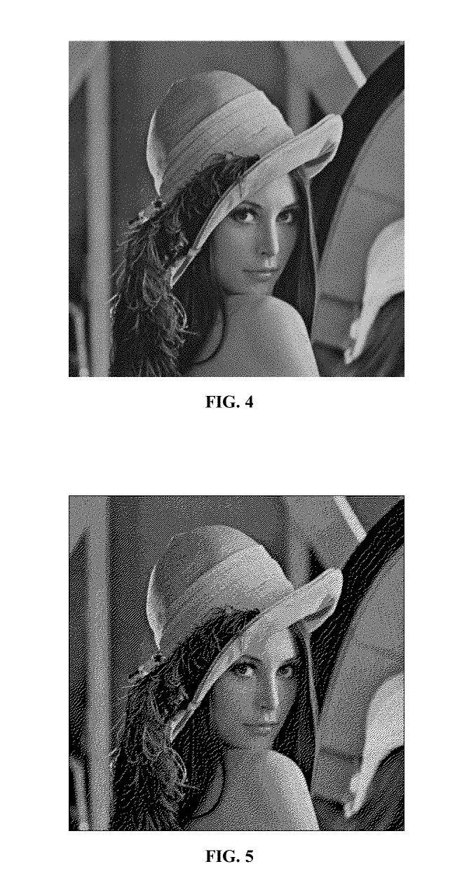

FIG. 5 illustrates a halftone image processed by a current error diffusion filter, and FIG. 7 illustrates a partially enlarged view of the halftone image of FIG. 5. It can be seen clearly in FIG. 7 that artificial textures appear in the middle part of the image.

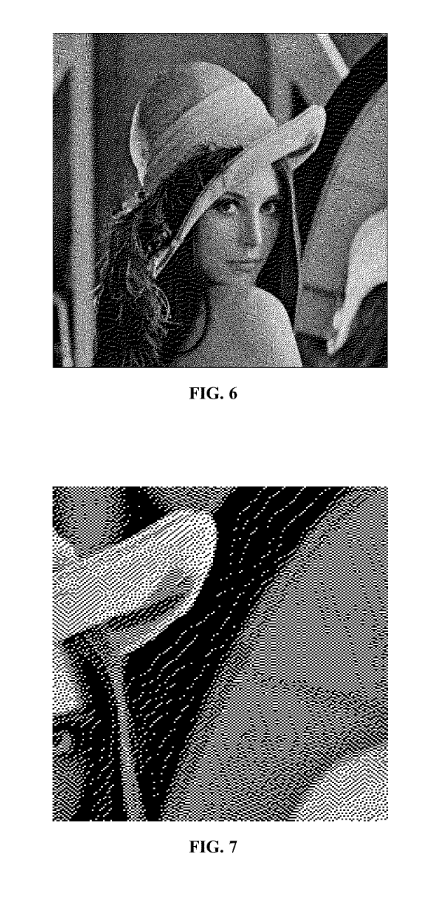

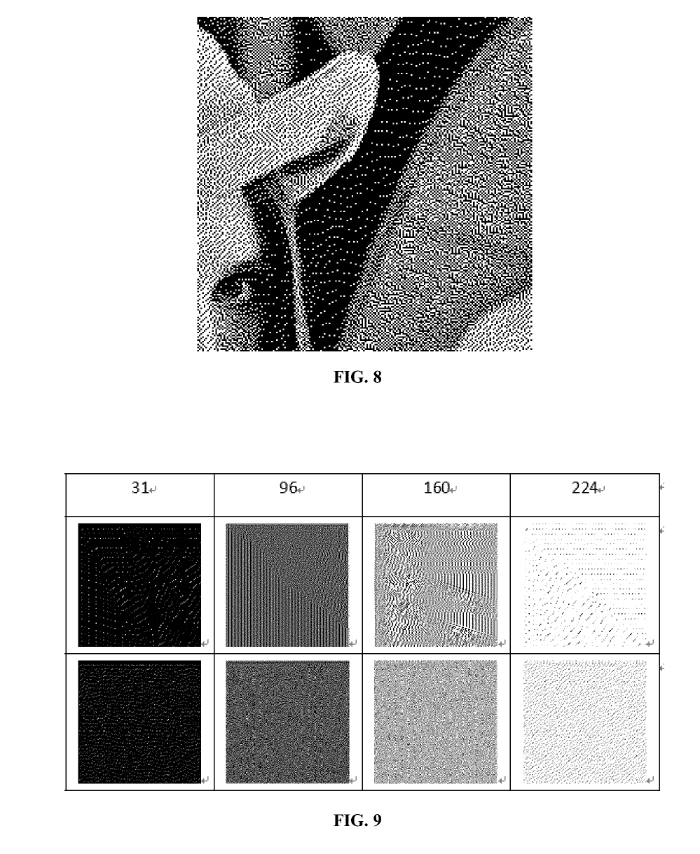

FIG. 6 illustrates a schematic view of a halftone image processed by an image processing apparatus in accordance with some embodiments of the present disclosure, and FIG. 8 illustrates a partially enlarged view of the halftone image of FIG. 6. As can be clearly seen from FIG. 8, the disclosed self-adaptive error diffusion weighting method applied in FIG. 8 can reduce the number of artificial textures.

Referring to FIG. 9, image comparison effect diagrams processed respectively by a current error diffusion method (upper row) and by a disclosed error diffusion method (lower row). As can be clearly seen from the image comparison effect diagrams, by applying the disclosed self-adaptive error diffusion weighting processing method, the artificial texture caused by the error diffusion processing method using a fixed weight can be greatly reduced. Therefore, the disclosed image processing method can significantly reduce the probability of artificial texture appearance, and improve the image processing effect.

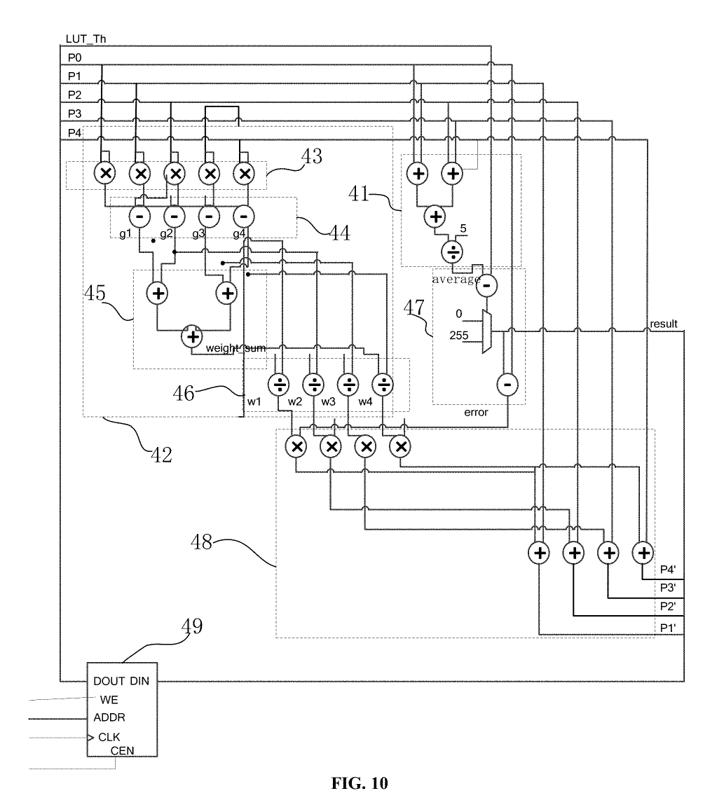

In some other embodiments, the present disclosure provides another exemplary method for dynamically adjusting the error diffusion process weight value. Different from the embodiments discussed above in connection with FIG. 1, the predetermined function used in step S107 can be different. The detailed technical solution of such embodiments is explained in the following with reference to FIG. 10. It should be noted that, description of the same or similar steps or components are not repeated here.

Referring to FIG. 10, a hardware circuit diagram of another exemplary image processing apparatus in accordance with the other embodiments of the present disclosure is shown. The error diffusion weight coefficient calculator 302 provided here does not include the gradient computing unit array (i.e., the absolute value computing unit array 303), but include a variance computing unit array.

The variance computing unit array can include a square value computing unit array 43 and a subtraction computing unit array 44. The error diffusion processor, the average value generator, and the threshold comparison unit shown in FIG. 10 have different labels with those shown in FIG. 3, but the error diffusion processor, the average value generator, and the threshold comparison unit have the same functions described above in connection with FIG. 3. For simplicity, the description thereof is not repeated here.

According to the hardware circuit shown in FIG. 10, equation (4) can be different. In certain embodiments, the predetermined function can be a variance function:

$$w ( m , n ) = \frac{\vert {src ( i , j )}^{2} - {src ( i + m , j + n )}^{2} \vert}{Y + {\sum }_{m = - M}^{M 2} {\sum }_{n = - N 1}^{N 2} \vert {src ( i , j )}^{2} - {src ( i + m , j + n )}^{2} \vert} , \qquad ( 6 ) .$$

Using the equation (6) to perform the error diffusion process to the neighboring regions shown in Table 1 and Table 2 respectively, the following results can be obtained.

The error diffusion process weight value of each adjacent point in the neighboring region of Table 1 can be obtained as:

$$w ( 1 , 0 ) = \frac{\vert {67}^{2} - {95}^{2} \vert}{1 + \vert {67}^{2} - {95}^{2} \vert + \vert {67}^{2} - {67}^{2} \vert + \vert {67}^{2} - {78}^{2} \vert + \vert {67}^{2} - {106}^{2} \vert} = \frac{4536}{12879}$$

$$w ( - 1 , - 1 ) = \frac{\vert {67}^{2} - {67}^{2} \vert}{1 + \vert {67}^{2} - {95}^{2} \vert + \vert {67}^{2} - {67}^{2} \vert + \vert {67}^{2} - {78}^{2} \vert + \vert {67}^{2} - {106}^{2} \vert} = 0$$

$$w ( 0 , 1 ) = \frac{\vert {67}^{2} - {78}^{2} \vert}{1 + \vert {67}^{2} - {95}^{2} \vert + \vert {67}^{2} - {67}^{2} \vert + \vert {67}^{2} - {78}^{2} \vert + \vert {67}^{2} - {106}^{2} \vert} = \frac{1595}{12879}$$

$$w ( 1 , 1 ) = \frac{\vert {67}^{2} - {106}^{2} \vert}{1 + \vert {67}^{2} - {95}^{2} \vert + \vert {67}^{2} - {67}^{2} \vert + \vert {67}^{2} - {78}^{2} \vert + \vert {67}^{2} - {106}^{2} \vert} = \frac{6747}{12879}$$

The error diffusion process weight value of each adjacent point in the neighboring region of Table 2 can be obtained as:

$$w ( 1 , 0 ) = \frac{\vert {177}^{2} - {140}^{2} \vert}{\begin{matrix}1 + \vert {177}^{2} - {140}^{2} \vert + \vert {177}^{2} - {167}^{2} \vert + \\ \vert {177}^{2} - {134}^{2} \vert + \vert {177}^{2} - {121}^{2} \vert\end{matrix}} = \frac{11729}{45231}$$

$$w ( - 1 , - 1 ) = \frac{\vert {177}^{2} - {167}^{2} \vert}{\begin{matrix}1 + \vert {177}^{2} - {140}^{2} \vert + \vert {177}^{2} - {167}^{2} \vert + \\ \vert {177}^{2} - {134}^{2} \vert + \vert {177}^{2} - {121}^{2} \vert\end{matrix}} = \frac{3440}{45231}$$

$$w ( 0 , 1 ) = \frac{\vert {177}^{2} - {134}^{2} \vert}{\begin{matrix}1 + \vert {177}^{2} - {140}^{2} \vert + \vert {177}^{2} - {167}^{2} \vert + \\ \vert {177}^{2} - {134}^{2} \vert + \vert {177}^{2} - {121}^{2} \vert\end{matrix}} = \frac{13373}{45231}$$

$$w ( 1 , 1 ) = \frac{\vert {177}^{2} - {121}^{2} \vert}{\begin{matrix}1 + \vert {177}^{2} - {140}^{2} \vert + \vert {177}^{2} - {167}^{2} \vert + \\ \vert {177}^{2} - {134}^{2} \vert + \vert {177}^{2} - {121}^{2} \vert\end{matrix}} = \frac{16688}{45231}$$

After error diffusion processing, the error-diffusion-processed pixel values of the adjacent points in the neighboring regions of Table 1 and Table 2 can be shown in Table 3 and Table 4 below respectively.

TABLE 3

| | | |
|---|---|---|
| * | 67 | 118 |
| 67 | 86 | 161 |

TABLE 4

| | | |
|---|---|---|
| * | 177 | 120 |
| 161 | 111 | 92 |

According to the above-described embodiments of the present disclosure, the weight values of the error diffusion process are also calculated based on a predetermined function of the pixel values of the center point and the adjacent points in the neighboring region. Therefore, the error diffusion can be dynamically adjusted according to the local pixel characteristics of the neighboring regions. And the same image processing effect as described above in connection with FIGS. 1-9 can be achieved.

Although the disclosed subject matter has been described and illustrated in the foregoing illustrative embodiments, it is understood that the present disclosure has been made only by way of example, and that numerous changes in the details of embodiment of the disclosed subject matter can be made without departing from the spirit and scope of the disclosed subject matter, which is only limited by the claims which follow. Features of the disclosed embodiments can be combined and rearranged in various ways. Without departing from the spirit and scope of the disclosed subject matter, modifications, equivalents, or improvements to the disclosed subject matter are understandable to those skilled in the art and are intended to be encompassed within the scope of the present disclosure. It should be noted that, similar reference numerals and letters are refer to similar items in the figures, and thus once an item is defined in one figure, it can be no further defined and explained in the subsequent figures.

What is claimed is:

1. A method for image processing, comprising:
(a) determining a neighboring region in an original image for error diffusion process, the neighboring region including a center point and at least one adjacent point of the center point;
(b) based on pixel values of the center point and the at least one adjacent point, calculating an error diffusion process weight value for each adjacent point in the neighboring region corresponding to an error diffusion process from the center point towards each adjacent point;
(c) after binarizing the pixel value of the center point, calculating an error value according to the binarized pixel value of the center point; and
(d) adding a product of the error diffusion process weight value for each adjacent point and the error value to the pixel value of each adjacent point in the neighboring region respectively to obtain an error-diffusion-processed pixel value for each adjacent point in the neighboring region.

2. The method of claim 1, wherein:
the error diffusion process weight value for each adjacent point is calculated based on a predetermined function of the pixel values of the center point and the adjacent points in the neighboring region.

3. The method of claim 1, further comprising:
selecting another pixel in the original image that is directly adjacent to the center point as a next center point;
determining a next neighboring region of the next center point, the next neighboring region includes the next center point and at least one adjacent point of the next center point;
based on pixel values of the next center point and the at least one adjacent point in the next neighboring region, calculating an error diffusion process weight value for each adjacent point in the next neighboring region corresponding to an error diffusion process from the next center point towards each adjacent point in next neighboring region;
binarizing the pixel value of the next center point, and calculating an error value according to the binarized pixel value of the next center point; and
adding a product of the error diffusion process weight value for each adjacent point in the next neighboring region and the error value to the pixel value of each adjacent point in the next neighboring region respectively to obtain an error diffusion processed pixel value for each adjacent point in the next neighboring region.

4. The method of claim 2, wherein:
the predetermined function is
$$w ( m , n ) = \frac{\vert src ( i , j ) - src ( i + m , j + n ) \vert}{Y + {\sum }_{m = - M 1}^{M 2} {\sum }_{n = - N 1}^{N 2} \vert src ( i , j ) - src ( i + m , j + n ) \vert} ;$$
src(i, j) is the pixel value of the center point (i, j) in the neighboring region;
src(i+m, j+n) is the pixel value of the adjacent point (i+m, j+n) that is located at the m column right side of the center point and n row down side of the center point;
w(m, n) is the error diffusion process weight value of the adjacent point (i+m, j+n) in the neighboring region;
M2 is a maximum value of m when the adjacent point in located on the right side of the center point;
N2 is a maximum value of n when the adjacent point is located below the center point;
M1 is a maximum absolute value of m when the adjacent point is located on the left side of the center point;
N1 is a maximum absolute value of n when the adjacent point is located above the center point; and
Y is a predetermined integer value arbitrarily selected from 1-255.

5. The method of claim 2, wherein:
the predetermined function is
$$w ( m , n ) = \frac{\vert {src ( i , j )}^{2} - {src ( i + m , j + n )}^{2} \vert}{Y + {\sum }_{m = - M 1}^{M 2} {\sum }_{n = - N 1}^{N 2} \vert {src ( i , j )}^{2} - {src ( i + m , j + n )}^{2} \vert} ;$$
src(i, j) is the pixel value of the center point (i, j) in the neighboring region;
src(i+m, j+n) is the pixel value of the adjacent point (i+m, j+n) that is located at the m column right side of the center point and n row down side of the center point;
w(m, n) is the error diffusion process weight value of the adjacent point (i+m, j+n) in the neighboring region;
M2 is a maximum value of m when the adjacent point in located on the right side of the center point;
N2 is a maximum value of n when the adjacent point is located below the center point;
M1 is a maximum absolute value of m when the adjacent point is located on the left side of the center point;
N1 is a maximum absolute value of n when the adjacent point is located above the center point; and
Y is a predetermined integer value arbitrarily selected from 1-255.

6. The method of claim 1, wherein binarizing the pixel value of the center point includes:
calculating an average pixel value of the neighboring region;
if the average pixel value of the neighboring region is less than or equal to a preset threshold value, assigning a first fixed value to the binarized pixel value of the center point; and
if the average pixel value of the neighboring region is larger than the preset value, assigning a second fixed value to the binarized pixel value of the center point, the second fixed value is different than the first fixed value.

7. The method of claim 6, wherein the preset threshold value is calculated based on the pixel values of the center point and adjacent points in the neighboring region.

8. The method of claim 6, wherein:
the average pixel value of the neighboring region is calculated by
$$Average = \frac{{\sum }_{m = - M 1}^{M 2} {\sum }_{n = - N 1}^{N 2} src ( i + m , j + n )}{( M 1 + M 2 + 1 ) \times ( N 1 + N 2 + 1 ) - Z} ;$$
the “Average” is the average of the pixel values of all the pixels including the center point and all adjacent points in the neighboring region;
src(i+m, j+n) is the pixel value of the adjacent point (i+m, j+n) that is located at the m column right side of the center point and n row down side of the center point;
Z is a total number of pixel points in the neighboring region that do not participate in the error diffusion;
N1+N2+1 is a total number of rows in the neighboring region; and
M1+M2+1 is a total number of columns in the neighboring region.

9. The method of claim 6, wherein calculating the error value according to the binarized pixel value of the center point includes:
subtracting the binarized pixel value of the center point from the pixel value of the center point.

10. The method of claim 1, wherein:
the error-diffusion-processed pixel value of each adjacent point in the neighboring region is calculated by src(i+m, j+n)′=w(m,n)×error+src(i+m, j+n);
src(i+m, j+n) is the pixel value of the adjacent point (i+m, j+n) that is located at the m column right side of the center point and n row down side of the center point;
w(m, n) is the error diffusion process weight value of the adjacent point (i+m, j+n);
error is the error value; and
src(i+m, j+n)′ is the error diffusion processed pixel value of the adjacent point (i+m, j+n) in the neighboring region of the central point (i, j).

11. An apparatus for image processing, comprising:
a neighboring region error diffusion matrix generator configured for determining a neighboring region in an original image for error diffusion process, the neighboring region includes a center point and at least one adjacent point of the center point;
an error diffusion weight coefficient calculator configured for, based on pixel values of the center point and the at least one adjacent point, calculating an error diffusion process weight value for each adjacent point in the neighboring region corresponding to an error diffusion process from the center point towards each adjacent point;
an error diffusion binarization calculator configured for binarizing the pixel value of the center point, and calculating an error value according to the binarized pixel value of the center point; and
an error diffusion processor configured for adding a product of error diffusion process weight value for each adjacent point and the error value to the pixel value of each adjacent point in the neighboring region respectively to obtain an error diffusion processed pixel value for each adjacent point in the neighboring region.

12. The apparatus of claim 11, wherein the error diffusion weight coefficient calculator includes:
a gradient computing unit array connected to the center point and each adjacent point in the neighboring region;
a first summation computing unit array connected to the gradient computing unit array; and
a division computing unit array connected to both of the gradient computing unit array and the first summing computing unit array.

13. The apparatus of claim 11, wherein the error diffusion weight coefficient calculator includes:
a variance computing unit array including a square value computing unit array and a subtraction computing unit array connected to the center point and each adjacent point in the neighboring region;
a first summation computing unit array connected to the gradient computing unit array; and
a division computing unit array connected to both of the gradient computing unit array and the first summing computing unit array;
the variance computing unit array includes a square value computing unit array and a subtraction computing unit array.

14. The apparatus of claim 11, wherein:
the neighboring region error diffusion matrix generator is further configured for selecting another pixel in the original image that is directly adjacent to the center point as a next center point, and determining a next neighboring region of the next center point, the next neighboring region includes the next center point and at least one adjacent point of the next center point;
the error diffusion weight coefficient calculator is further configured for, based on pixel values of the next center point and the at least one adjacent point in the next neighboring region, calculating an error diffusion process weight value for each adjacent point in the next neighboring region corresponding to an error diffusion process from the next center point towards each adjacent point in next neighboring region;
the error diffusion binarization calculator is further configured for binarizing the pixel value of the next center point, and calculating an error value according to the binarized pixel value of the next center point; and
the error diffusion processor is further configured for adding a product of the error diffusion process weight value for each adjacent point in the next neighboring region and the error value to the pixel value of each adjacent point in the next neighboring region respectively to obtain an error diffusion processed pixel value for each adjacent point in the next neighboring region.

15. The apparatus of claim 12, wherein the error diffusion binarization calculator includes:
a second summation computing unit array connected to the center point and each point in the neighboring region;
an average value computing unit connected to the second summation computing unit array; and
a threshold comparison unit connected to the average value computing unit.

16. The apparatus of claim 15, wherein the error diffusion processor includes:
a multiplication computing unit array connected to both of the error diffusion weight coefficient calculator and the error diffusion binarization calculator; and
a third summation computing unit array connected to the multiplication computing unit array, the center point and each adjacent point in the neighboring region.

17. The apparatus of claim 11, wherein the error diffusion binarization calculator is further configured for subtracting the binarized pixel value of the center point from the pixel value of the center point to obtain the error value.

18. The apparatus of claim 13, wherein the error diffusion binarization calculator includes:
a second summation computing unit array connected to the center point and each point in the neighboring region;
an average value computing unit connected to the second summation computing unit array; and
a threshold comparison unit connected to the average value computing unit.

19. The apparatus of claim 18, wherein the error diffusion processor includes:
a multiplication computing unit array connected to both of the error diffusion weight coefficient calculator and the error diffusion binarization calculator; and
a third summation computing unit array connected to the multiplication computing unit array, the center point and each adjacent point in the neighboring region.

20. A device for forming an image, comprising:
a reading apparatus for providing raw image processing data of the original image;
an image parameter acquiring apparatus configured for acquiring pixel values of the original image;
an image processing apparatus of claim 11 connected to the image parameter acquiring apparatus; and
an output apparatus for outputting processed data generated by the image processing apparatus.
